(19) United States
(12) Patent Application Publication
(10) Pub. No.: US 2020/0408006 A1
(43) Pub. Date: Dec. 31, 2020

(54) Handle Device

(71) Applicant: Huf Hülsbeck & Fürst GmbH & Co. KG, Velbert (DE)

(72) Inventors: Markus Bartels, Mülheim (DE); Alexander Fromme, Velbert (DE); Thomas Kittel, Velbert (DE)

(21) Appl. No.: 16/981,840

(22) PCT Filed: Feb. 28, 2019
(86) PCT No.: PCT/EP2019/054974

§ 371 Date: Sep. 17, 2020

(30) Foreign Application Priority Data
Mar. 28, 2018 (DE) 10 2018 107 504.9

(51) Int. Cl. E05B 79/06; E05B 79/22; E05B 85/10; E05B 85/06

(52) U.S. Cl. CPC E05B 79/06; E05B 79/22; E05B 85/10; E05Y 2800/45; E05Y 2201/22; E05Y 2900/531; E05B 85/06

(57) ABSTRACT

The invention relates to a handle device (1) for a movable part, in particular a door or a lid, of a vehicle, with a, in particular fixed, handle part (10) for actuating the movable part, a carrier element (20) for fixing the handle part (10) to the movable part, wherein a locking cylinder (23) for unlocking the movable part at least in an emergency can be arranged on the carrier element (20), wherein a reinforcing element (13) is provided on the handle part (10), in which the locking cylinder (23) can be received at least partially, and wherein a fixing unit (30) is provided between the handle part (10) and the reinforcing element (13) in order to fix the reinforcing element (13) to the handle part (10) in a form- and/or force-locking manner.

The invention relates to a handle device for a movable part, in particular a door or a lid, of a vehicle according to the preamble of the independent device claim, which is designed with a, in particular fixed, handle part for actuating the movable part and a carrier element for fixing the handle part to the movable part. Furthermore, the invention relates to a method for assembling a corresponding handle device according to the preamble of the independent method claim.

Handle devices for vehicle doors are generally known, e.g. from the document DE 10 2007 027 845 A1. Known handle devices are usually designed with a handle part for actuating a vehicle door and a carrier element for fixing the handle part to the vehicle door. Often the handle devices are designed as keyless devices. In some handle devices, a locking cylinder is still fixed to the handle part to allow access to the interior of the vehicle in case of an emergency, e.g. if the electronics of a keyless system fail. To fix such a handle part to the carrier element, several complicated assembly steps often have to be performed until the handle part and the locking cylinder are fixed to the carrier element. Such handle devices are therefore complex to assemble.

The object of the present invention is therefore to provide a handle device for a movable part, in particular a door or a lid, of a vehicle, which at least partially overcomes the disadvantages mentioned above. In particular, it is an object of the present invention to create a handle device which is simply constructed and which can be assembled on the movable part easily, quickly and without high assembling effort. Furthermore, a method for the assembly of such a handle device shall be provided. In particular, the method shall enable the assembly of the handle device to be improved, preferably simplified.

The present object is solved by a handle device with the features of the independent device claim, in particular from the characterizing portion. Also a method for the assembly of a door handle system with the features of the independent method claim, in particular from the characterizing portion, is proposed for the solution of the object. The dependent device and method claims show preferred further developments of the invention. Features that are disclosed for the individual embodiments of the inventive handle device and the inventive method can be combined with each other in such a way that with respect to the disclosure for the embodiments of the inventive handle device and the inventive method reference is or can always be made to each other. Furthermore, the method according to the invention can be performed for the assembly of the handle device according to the invention.

The handle device according to the invention for a movable part, in particular a door or a lid, of a vehicle is designed with a, in particular fixed, handle part for actuating the movable part and a carrier element for fixing the handle part to the movable part, wherein a locking cylinder for unlocking the movable part at least in an emergency can be arranged on the carrier element, wherein a reinforcing element is provided on the handle part, in which the locking cylinder can be at least partially received, and wherein a fixing unit is provided between the handle part and the reinforcing element in order to fix the reinforcing element to the handle part in a form-locking and/or force-locking manner.

The device according to the invention can be used on a vehicle door from the driver's side as well as from the passenger's side and on rear vehicle doors or a trunk lid. The carrier element can be understood as any part in relation to the movable part for the assembly of the handle part. In particular, the handle part can be designed as a fixed external door handle which is immovably fixed to the movable part of the vehicle, such as a vehicle door.

The inventive idea here is that the locking cylinder can be pre-assembled on the carrier element, while the reinforcing element for the locking cylinder, a so-called “socket”, can be fixed to the handle part. The “socket” for the protection of the locking cylinder can, for example, be embedded in the fixed door handle via an engaging connection (an example of a first fixing unit in the sense of the invention). In order to fix such a handle device to the movable part of the vehicle, only two individually manageable units need to be managed, namely the carrier element (with the locking cylinder already pre-assembled) on the one hand and the handle part (with the reinforcing element for the locking cylinder already pre-fixed) on the other hand. The installer can easily and comfortably handle the carrier element with one hand and the handle part with the other hand. The carrier element is arranged from an inside of the movable part and the handle part from an outside of the movable part. The carrier element and the handle part are assembled to the movable part by interaction. Thus, the assembly of the handle device can be done in only one assembly step, namely by executing only one plug-in movement of the handle part on the carrier element. To secure the fixing of the two units to each other, namely the carrier element and the handle part, and thus the handle device on the movable part, a plate-like securing element can be used, which can prevent the handle part from loosening from the carrier element. Thus, the handle device can be secured to the movable part in a loss-proof manner. In summary, it can be noted that the assembly of the handle device on the movable part can be considerably simplified by means of the invention.

Furthermore, it is conceivable that the locking cylinder in the handle part can preferably be arranged behind a cap. It is also conceivable that the locking cylinder can act directly mechanically on a ratchet in a door lock of the movable part, so that a purely electrical actuation of the movable part for opening and/or closing can be enabled without having to move the handle part relative to the movable part. This means that the emergency locking cylinder does not release the central locking system, but interacts directly mechanically with the lock or the ratchet.

Furthermore, it may be provided within the scope of the invention in the case of a handle device that a locking cylinder is arranged on the carrier element, wherein the reinforcing element is designed in the form of a solid collar element for the locking cylinder in order to enclose the locking cylinder at least partially on the circumference in the mounted state of the handle device. In this way, the locking cylinder can be secured against manipulation from the outside. The burglary resistance of the handle device according to the invention can be thus increased.

Furthermore, it may be provided within the scope of the invention in the case of a handle device that the reinforcing element comprises a, preferably cylindrical, receptacle for the locking cylinder. Thus, the reinforcing element according to the invention can enclose the locking cylinder in such a way that there are hardly any points of attack on the locking cylinder with a possible tool. Thus, the burglary resistance of the handle device according to the invention can be considerably increased.

It is also conceivable in the case of a handle device within the scope of the invention that the reinforcing element is formed from a metal, an alloy or a ZAMAK alloy. Modern handle devices are increasingly made of plastic materials to reduce their weight. However, such handle devices can be damaged by a burglary tool. In order to avoid manipulation of the locking cylinder, the reinforcing element made of a solid material is used, which cannot be easily cut through, e.g. sawed or cut to pieces.

Furthermore, it may be provided within the scope of the invention in the case of a handle device that the reinforcing element is designed in the form of an aperture, wherein in particular the reinforcing element is formed from a plastic, preferably as an injection molded part. Thus, a handle device for a driver's door can also be provided identical in construction for a passenger door. Often no locking cylinder is mounted at the passenger door. This eliminates the need to use a solid reinforcing element on the passenger door. The same forming of the reinforcing element for the driver's door and the passenger door, but from different materials, can be used to enable a uniform appearance on the vehicle. Also in the case of a passenger door with a reinforcing element from a plastic material, the invention can be used to simplify the assembly of the handle device on the movable part, in this case the passenger door, because also in the case of a passenger door only two units, namely the handle part with the aperture and the carrier element, have to be handled, which can be assembled together, and thus on the passenger door, in only one assembling step.

Furthermore, it may be provided within the scope of the invention in the case of a handle device that a second fixing unit is provided between the carrier element and the reinforcing element in order to fix the reinforcing element to the carrier element in a form-locking and/or force-locking manner. The reinforcing element can thus serve not only to secure the locking cylinder but also to fix the handle part to the carrier element. Thus, the handle device can be reliably fixed to the movable part.

Furthermore, in the case of a handle device, the invention may provide that the fixing unit forms part of a guiding unit which is designed in such a way to guide the handle part in a form-locking manner at the assembly on the carrier element. The guiding unit can be provided between the handle part and the carrier element. Thus, the functionality of the fixing unit can be extended. The fixing unit can thus not only be used to fix the reinforcing element to the handle part, but also to guide the handle part during the assembly on the carrier element. The guiding unit can preferably form a form-locking guide between the handle part and the carrier element, so that the handle part can be inserted in only one orientation on the carrier element, which is predetermined by the guiding unit. The guiding unit provides the installer with a tactile feedback about a correct insertion movement of the handle part into the carrier element. Thus, the insertion movement of the handle part into the carrier element can be performed intuitively and haptically comprehensible. Furthermore, the guiding unit enables the correct position of the handle part on the carrier element to be set quickly, precisely and easily controlled. Thus, the assembly of the handle device according to the invention can be improved even further.

Furthermore, it may be provided within the scope of the invention that the guiding unit can form a linear guide for the handle part at the assembly on the carrier element. The linear guide can be provided at least for one, in particular for both ends of the handle part. Such a linear guiding unit can significantly improve the assembly of the handle part on the carrier element. The handle part can be easily inserted on the carrier element in only one assembling step and by means of only one insertion movement in the correct direction. For this purpose, the installer must position the handle part with the handle body parallel to the surface of the movable part and then insert the handle part on the carrier element with both ends simultaneously in only one linear insertion movement towards the surface of the movable part. At least one, and in particular both ends of the handle part can be received in a form-locking manner in the carrier element. Such an insertion movement of the handle part enables a simple, intuitive and easily controllable assembly of the handle device on the movable part. The correctness of the assembly can be recognized by the installer by tactile means, if the handle part is received in a form-locking manner in the, preferably linear, guide.

Furthermore, the invention may provide that the handle part may comprise a first holding means and a second holding means at opposite ends along its longitudinal extension. Advantageously, the handle part can interact mechanically with the carrier element via the first holding means and via the second holding means for fixing. For the handle part to interact mechanically with the carrier element for fixing, corresponding openings can be provided in the carrier element as bearing positions in which the first holding means and the second holding means can be received, preferably in a form-locking manner.

In addition, the first holding means can form a part of the fixing unit. The first holding means can thus not only contribute to the fixing of the handle part to the carrier element, but also to the fixing of the reinforcing element to the handle part.

In addition, the first holding means and the second holding means can be linear and form a part of the guiding unit. It is conceivable that the first holding means and the second holding means can be designed as linear protruding projections at the opposite ends of the handle part. The first holding means and the second holding means can protrude in the same direction from the handle part and can be aligned essentially parallel to each other. In addition, it is conceivable that the first holding means and the second holding means can be aligned in such a way that they can be received in the carrier element essentially perpendicular to the extension direction of the carrier element. By means of such holding means not only the handle part can be designed in a simple and cost-effective way, but also the construction of the entire handle device, including the carrier element for receiving the holding means, can be simplified. Another advantage is that the first holding means and the second holding means can form a part of the guiding unit. Thus, the first holding means and the second holding means can advantageously not only contribute to the fixing of the handle part to the carrier element, but also to a simple, controllable and more precise assembly.

Furthermore, in the case of a handle device within the scope of the invention, it is conceivable that the reinforcing element comprises a bearing arm which forms a part of the fixing unit, wherein in particular the handle part, in particular the first holding means, comprises a bearing guide, wherein preferably the bearing guide is designed complementary to the bearing arm in order to produce a form- and/or force-locking connection of the handle part with the reinforcing element. By means of the bearing arm, the reinforcing element can be received in a bearing guide on the handle part, which can be formed on the first holding means. By inserting the bearing arm into the bearing guide, the bearing arm together with the first holding means can form a part of the guiding unit.

Furthermore, it is possible that the reinforcing element comprises a supporting surface and the handle part, in particular the first holding means, comprises a supporting side, which butt against each other in the fixed state of the reinforcing element on the handle part. By butting the supporting side of the handle part against the supporting surface of the reinforcing element, the end position of the reinforcing element on the handle part can be marked.

Furthermore, in the case of a handle device, the invention can provide that the reinforcing element comprises a positioning means and the handle part, in particular the first holding means, comprises a positioning receptacle which secures the reinforcing element in the fixed state on the handle part in a form- and/or force-locking manner at least in a longitudinal direction of the handle part. The positioning means on the reinforcing element and the positioning receptacle on the handle part engage into each other when the reinforcing element has reached the end position on the handle part when its bearing arm is inserted into the bearing guide on the first holding means. This end position of the reinforcing element upwards against the handle part is limited by the butting of the supporting side of the handle part against the supporting surface of the reinforcing element. Against a displacement of the reinforcing element to the side or in a longitudinal direction of the handle part, the reinforcing element can be secured by the positioning means on the reinforcing element and the positioning receptacle on the handle part. In order to prevent the end position of the reinforcing element from being released downwards from the handle part, corresponding engaging and counter-engaging elements can be formed on the reinforcing element and on the handle part, preferably in the region of the bearing guide on the first holding means.

In addition, the reinforcing element may comprise a stop opening and the handle part, in particular the first holding means, may comprise a stopping means, which engage into each other in the fixed state of the reinforcing element on the handle part. When interacting with the stopping means, the stop opening can also mark the end position of the reinforcing element on the handle part and prevent the reinforcing element from slipping from the handle part in a longitudinal direction of the handle part.

Furthermore, the invention may provide that the reinforcing element comprises an engaging element and the handle part, in particular the first holding means, comprises a counter-engaging element, which secure the reinforcing element in the fixed state on the handle part in a form- and/or force-locking manner, in particular against being pulled out. Thus, the end position of the reinforcing element can be secured downwards and away from the handle part. The engaging and counter-engaging elements on the reinforcing element and on the handle part thus serve to produce a form- and force-locking connection between the reinforcing element and the handle part.

Furthermore, it may be provided within the scope of the invention that the carrier element may comprise a first bearing position for the first holding means of the handle part and a second bearing position for the second holding means of the handle part. Advantageously, the first bearing position and the second bearing position can be used for the mechanical fixing of the handle part on the carrier element. In addition, the first bearing position and the second bearing position can form a part of the guiding unit. This comprises the advantage that the functionality of the handle device can be extended with only a few means, wherein the first bearing position and the second bearing position as a part of the guiding unit can not only contribute to the fixing of the handle part on the carrier element, but also to an easy, fast and safe assembly of the handle device to the movable part.

Furthermore, it may be provided within the scope of the invention that the guiding unit may comprise at least one assembling means on a first holding means and/or on a second holding means of the handle part. Advantageously, the assembling means can be designed to produce a form-locking guide of the handle part in the carrier element or the holding means of the handle part in the bearing positions of the carrier element. It is also conceivable that the assembling means can be designed in the form of a rib and/or a guiding receptacle. Such an assembling means is easy to produce and requires only a simple connecting partner for a form-locking guide according to the invention. Although it is conceivable that the holding means on the handle part can be designed as a whole corresponding to the openings at the bearing positions of the carrier element in order to realize a form-locking guide, however, a form-locking guide is easier and more reliable to realize with a specially designed assembling means. This is because the holding means as a whole can be designed with a certain clearance to the openings at the bearing positions in order to counteract tolerances in the production of the elements of the handle device or as a result of material properties. Furthermore, it is advantageous that the assembling means in the form of a rib and/or a guiding receptacle can define the correct direction of insertion of the handle part into the carrier element by the extension direction of the rib and/or the projection. Only if the handle part is inserted correctly into the carrier element along the extension direction of the rib and/or the projection, the assembling means can be moved in the carrier element or in a correspondingly designed bearing position. Advantageously, the assembling means prevents a tilting or a tilted insertion of the handle part into the carrier element. Thus, when inserting the handle part into the carrier element, the installer can haptically receive a feedback whether the insertion direction of the handle into the carrier element is correct.

Furthermore, within the scope of the invention, it is possible that the guiding unit can comprise at least one guiding means at a first bearing position and/or at a second bearing position of the carrier element, wherein in particular the guiding means can be designed as a corresponding means for the assembling means in order to produce a form-locking connection of the handle part with the carrier element. It is advantageous for the guiding means to serve as a connecting partner for the assembling means when producing a form-locking guide of the handle part in the carrier element or the holding means of the handle part in the bearing positions of the carrier element. It is also conceivable that the guiding means can be designed in the form of a guiding receptacle or a guiding rail. Such an assembling means is easy to produce. In addition, the guiding means in the form of a guiding receptacle or a guiding rail can advantageously specify a preferably linear insertion direction of the handle part into the carrier element by means of the assembling means. This makes it easier to fix the handle part on the carrier element.

In addition, the invention may provide that an assembling means on a first holding means and/or on a second holding means of the handle part may comprise a bore which can serve as a cable holder. The bore may extend along the assembling means and may receive different cables in a protected and bundled manner. The cables may lead to different sensors on the handle part, which may be provided to actuate the movable part. Thus, the assembling means can not only ensure a form-locking guide of the handle part in the carrier element, but also fulfill another important function, namely to enable a bundled, protected guidance of cables from the inside of the handle device behind the movable part to the outside handle part. This also allows the construction of the handle device to be considerably simplified, while at the same time significantly improving the functionality of the handle device.

In addition, the guiding unit can comprise at least one engaging means on a first holding means and/or on a second holding means of the handle part in order to fix an end assembling position of the handle part on the carrier element in a form- and/or force-locking manner. Thus, the installer can recognize the correct end assembling position of the handle part on the carrier element, as the engaging means can provide a clear tactile feedback to the installer when reaching the end assembling position. It is also conceivable that the engaging means is designed in the form of an engaging cam and/or an engaging receptacle. Thus, the engaging means can be easily designed. In addition, the engaging means can interact with a simple complementary connecting partner to fix the end assembling position of the handle part on the carrier element in a form- and/or force-locking manner. Furthermore, it is advantageous that the engaging means can generate a certain guiding resistance when the handle part is inserted into the carrier element shortly before the end assembling position is reached. In order to reach this end assembling position, the installer must once again overcome the small guiding resistance generated by the engaging means. Based on the tactile feedback, the installer finally knows that he has reached the correct end assembling position. Finally, the installer can mechanically secure the handle part in the end assembling position, for example with a securing element that can prevent the handle part from being pulled out of the carrier element by force.

Furthermore, it is conceivable that the guiding unit may comprise at least one fixing means at a first bearing position and/or at a second bearing position of the carrier element, wherein in particular the fixing means may be designed as a corresponding means to the engaging means in order to produce a form- and/or force-locking connection with the engaging means in the end assembling position of the handle part on the carrier element. Advantageously, the fixing means can be designed complementary to the engaging means in order to fix the end assembling position of the handle part on the carrier element in a form- and/or force-locking manner. It is conceivable here that the fixing means can be designed in the form of a fixing receptacle and/or a fixing cam. Such a fixing means is easy to form and can fix the end assembling position of the handle part on the carrier element in interaction with a corresponding engaging means.

Furthermore, it is possible for the guiding unit to comprise at least one pre-engaging means on the first holding means and/or on the second holding means of the handle part and/or on the first bearing position and/or on the second bearing position of the carrier element in order to guide the fixing means on the first bearing position and/or on the second bearing position of the carrier element and/or the engaging means on the first holding means and/or on the second holding means of the handle part in a form-locking manner during the assembly of the handle part on the carrier element before the end assembling position of the handle part on the carrier element is reached. Thus, the advantage can be achieved that during the insertion movement of the handle part into the carrier element, the engaging means at the first holding means and/or at the second holding means of the handle part and/or the fixing means at the first bearing position and/or at the second bearing position of the carrier element does not disturb a form-locking guidance of the handle part on the carrier element by the guiding unit at first. Shortly before reaching an end assembling position of the handle part on the carrier element, the pre-engaging means can end so that a guiding resistance for the engaging means and/or for the fixing means is created. In the end assembling position, the engaging means and the fixing means can be brought into a form- and/or force-locking connection, whereby the guiding resistance is released and a haptic feedback to the installer can be generated, which can mark the end assembling position.

Furthermore, it may be provided within the scope of the invention that the reinforcing element, in particular on a bearing arm, may comprise at least one pre-engaging means for guiding a fixing means at the first bearing position of the carrier element during the assembly of the handle part on the carrier element in a form-locking manner, before the end assembling position of the handle part on the carrier element is reached. The pre-engaging means on the reinforcing element can transfer into a pre-engaging means on the first holding means in order not to resist the fixing means at the first bearing position of the carrier element when the handle part is inserted into the carrier element. Thus, the reinforcing element can form a part of the guiding unit.

In addition, it may be provided within the scope of the invention that the handle part, in particular a first holding means and/or a second holding means of the handle part, may comprise at least one connecting means which can interact with a securing element in order to secure the handle part in an end assembling position of the handle part on the carrier element. In the end assembling position, the handle part is initially held on the carrier element by the engaging means and the fixing means, which produce a form- and/or force-locking connection with each other. The form- and/or force-locking connection between the engaging means and the fixing means can be released and the handle part can be removed from the carrier element by a forced pulling or by centrifugal forces, which can occur, for example, at high accelerations, which can act in the opposite direction to the insertion direction of the handle part on the carrier element. In order to prevent this, the handle part can be secured in the end assembling position by the securing element in a form- and/or force-locking manner, whereby the created form- and/or force-lock can preferably act perpendicular to the insertion direction of the handle part along the form-locking guide of the guiding unit. The securing element can extend essentially along the handle part. By displacing the securing element along the handle part, it can engage in the connecting means on the first holding means and/or on the second holding means of the handle part, so that a movement of the handle part perpendicular to the extension direction of the securing element is no longer possible because the securing element is in the way of such a movement. Consequently, the securing element can advantageously prevent the handle part from being pulled back along the form-locking guide of the guiding unit created for assembly without authorization and/or unintentionally.

Advantageously, a securing element may be provided within the scope of the invention, which may serve to secure the handle part in an end assembling position on the carrier element and/or the reinforcing element in the fixed state on the handle part, in particular by at least one connecting means on the handle part. It is conceivable that the securing element may be designed in one part in the form of a securing plate and/or in another part of a securing fork. The securing fork can be designed advantageously to receive and secure the handle part in a form- and/or force-locking manner. The securing plate can be assembled particularly easily and securely on the carrier element and can generate a high normal force to prevent the handle part from being pulled out of the carrier element. Thus, the handle part can be secured particularly easily and reliably in the end assembling position. For the reception of the securing element in the carrier element, a flat elongated receptacle can be provided in which the securing element can be arranged longitudinally displaceable, in particular along its extension direction. In addition, it is conceivable that the securing element can be arranged in the carrier element in a longitudinally displaceable way by means of an adjusting screw. By tightening the screw, the securing element can be easily moved to secure the handle part in the end assembling position against being pulled out. Thus, a simply designed handle device can be created which is safe in its operation and can also be easily assembled.

It is further conceivable that the handle device may be designed as a part of a locking system of the motor vehicle, in particular a keyless go system or a keyless entry system, wherein preferably at least one sensor element, preferably on the handle part, may be provided in order to electronically actuate the movable part. According to both alternatives the sensor element can be designed accordingly, e.g. as a contactless proximity sensor, a capacitive sensor or the like. Furthermore, it is conceivable that a security system for the locking system or at least an electronic unit for this purpose (as already mentioned) with a corresponding transmission and receiving unit for an identification request may be integrated completely or partially in the handle device, in particular in the handle part. An advantage is that such a locking system can automatically open and/or close the vehicle door during normal operation of the handle device without a mechanical locking cylinder if corresponding sensors in or on the door handle have been actuated. Thus, a fully automated locking system for a motor vehicle, preferably with a fixed handle part, can be provided.

Furthermore, the object according to the invention is solved by a method for assembling a handle device on a movable part, in particular a door or a lid, of a vehicle, which is designed with a, in particular fixed, handle part for actuating the movable part and a carrier element for fixing the handle part to the movable part, wherein a locking cylinder for unlocking the movable part at least in an emergency is provided on the carrier element, and wherein a reinforcing element for the locking cylinder is provided on the handle part, which at least partially encloses the locking cylinder on the circumference, wherein the reinforcing element is pre-assembled in the handle part and is assembled with the handle part from the outside on the movable part. Furthermore, the locking cylinder can be pre-assembled in the carrier element and assembled with the carrier element from the inside on the movable part. The same advantages are achieved as described above in relation to the handle device according to the invention. In order to avoid repetition, this is referred to in full in the present case.

Further measures and advantages as well as technical features of the invention result from the claims, the following description and the figures. Different features can be advantageous on their own and in any combination without leaving the scope of the invention. In the following figures, the handle device according to the invention is shown in detail in several embodiments. The figures show:

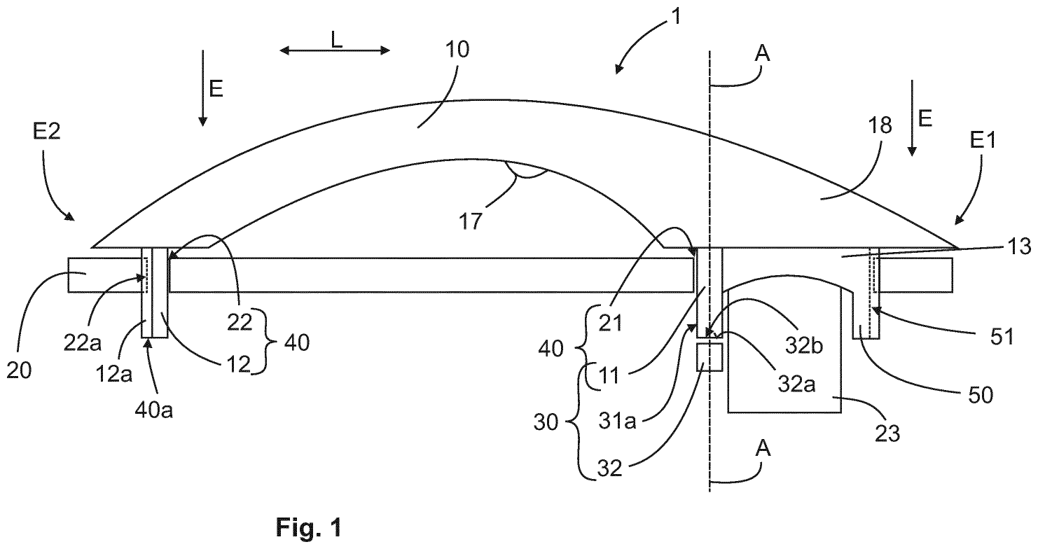

FIG. 1 sectional view of a handle device according to the invention,

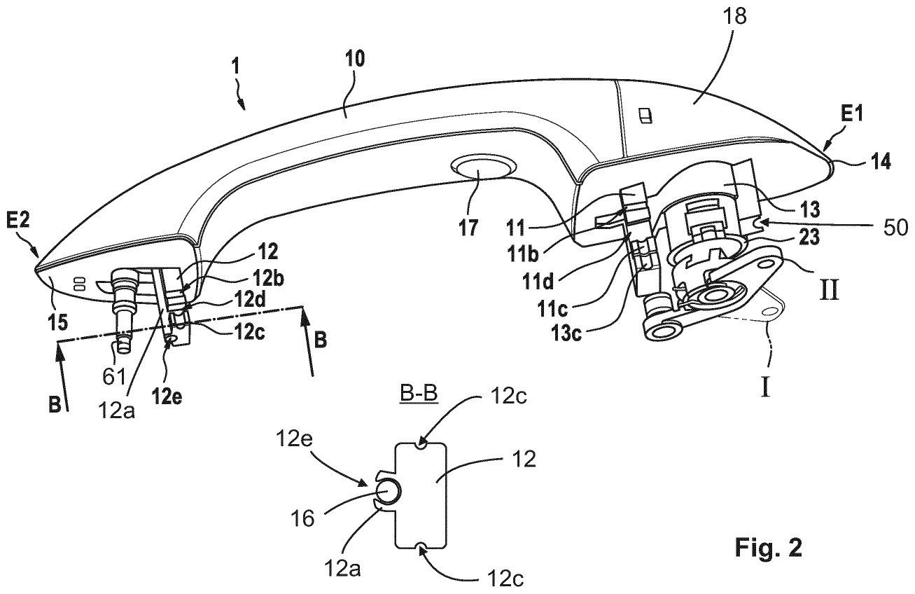

FIG. 2 perspective view of a handle part according to the invention,

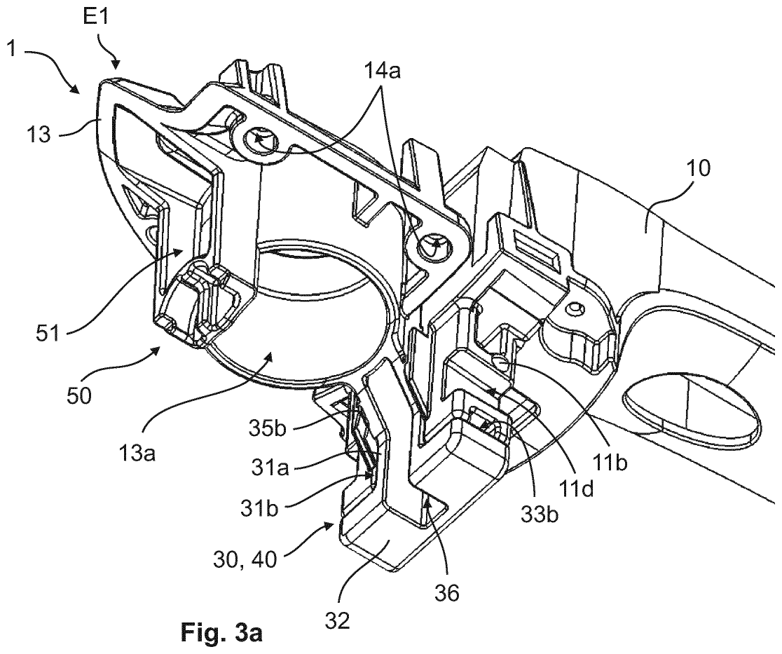

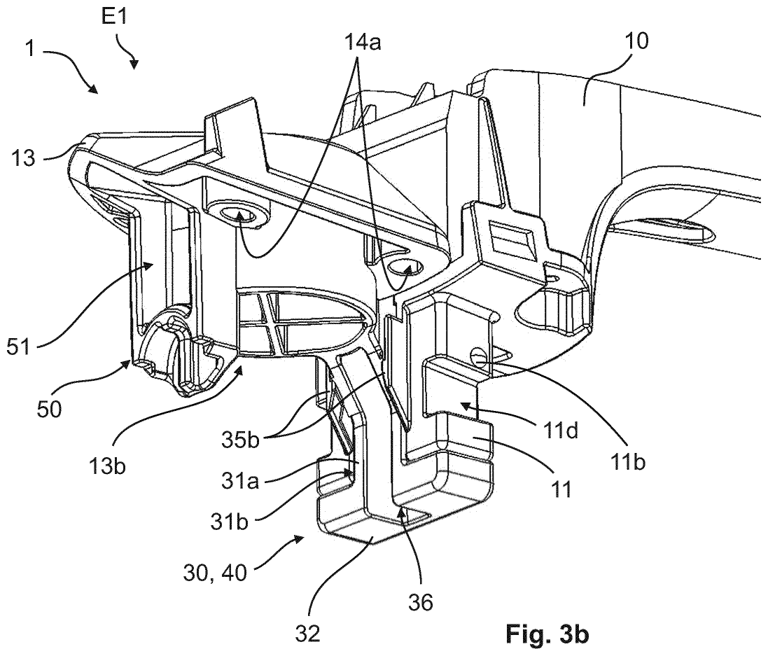

FIG. 3a a perspective view of a reinforcing element according to the invention for a driver's door,

FIG. 3b a perspective view of a reinforcing element according to the invention for a passenger door,

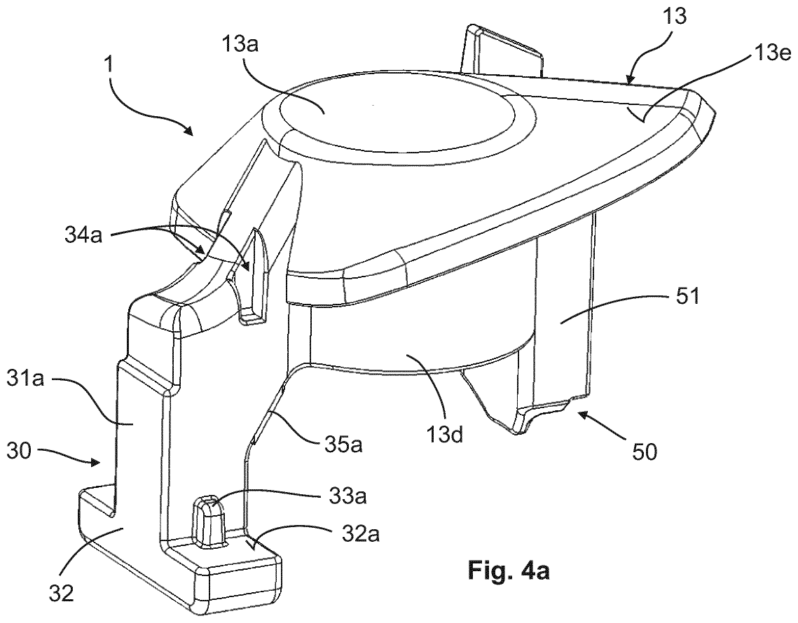

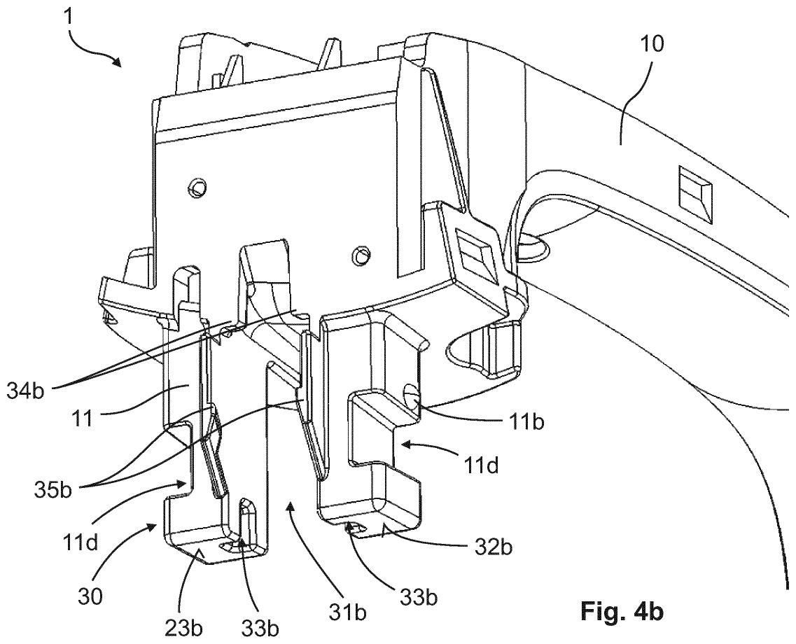

FIG. 4a a perspective view of a reinforcing element according to the invention in a unique position,

FIG. 4b a schematic view of a handle part with a fixing unit according to the invention for receiving a reinforcing element,

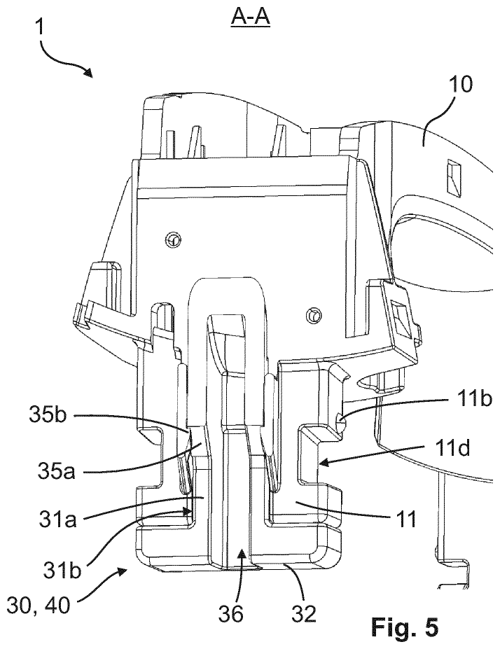

FIG. 5 a sectional view through a fixing unit according to the invention, transverse to an extension direction of a handle part,

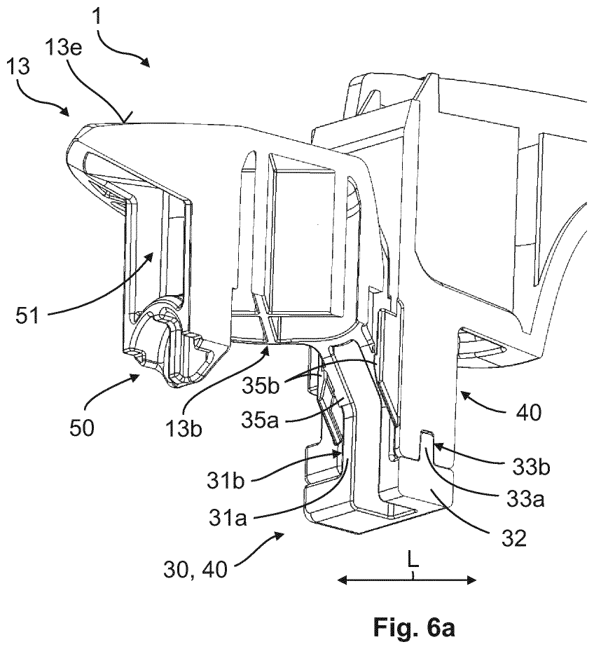

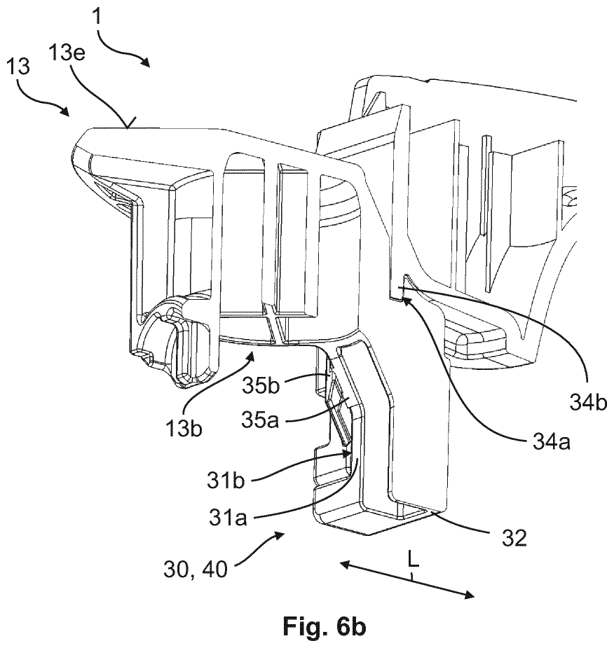

FIG. 6a a sectional view through a fixing unit according to the invention along an extension direction of a handle part,

FIG. 6b a sectional view through a fixing unit according to the invention along an extension direction of a handle part,

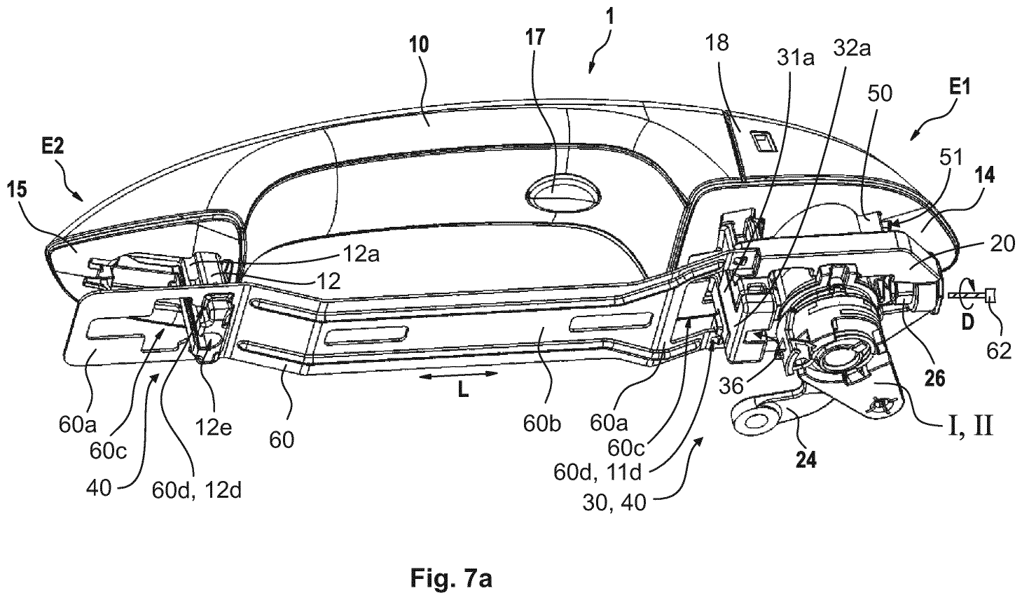

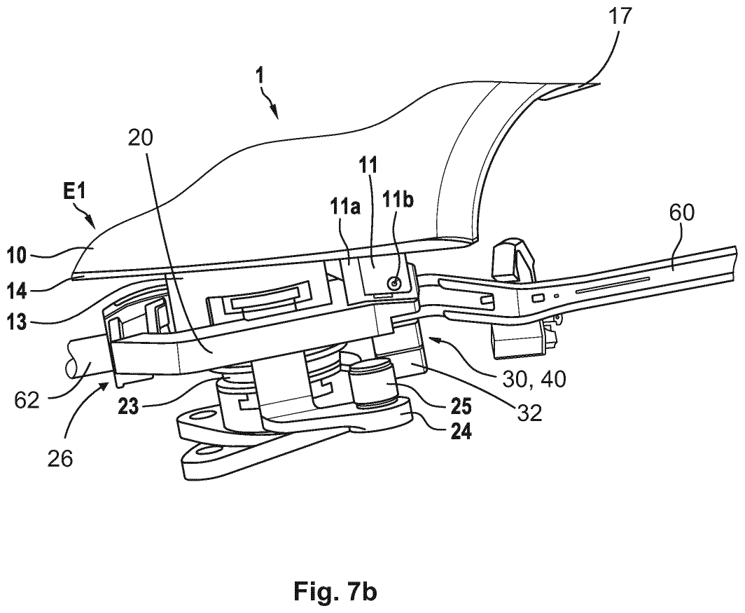

FIG. 7a a sectional view through a fixing unit according to the invention along an extension direction of a handle part, and

FIG. 7b a sectional view through a fixing unit according to the invention along an extension direction of the handle part.

In the following figures, the identical reference signs are used for the same technical features even from different embodiments.

FIG. 1 shows a handle device 1 according to the invention for a movable part, in particular a door or a lid, of a motor vehicle, wherein the motor vehicle and the movable part as a whole are not shown for reasons of simplicity. The handle device 1 is designed with a, preferably fixed, handle part 10 for actuating the movable part and a carrier element 20 for fixing the handle part 10 to the movable part. A locking cylinder 23 is pre-assembled on the carrier element 20. A reinforcing element 13 for the locking cylinder 23 is pre-fixed on the handle part 10. The handle part 10 is arranged on the outside and the carrier element 20 on the inside of the movable part. By fixing the handle part 10 to the carrier element 20, the handle device 1 is assembled on the movable part.

According to the invention, the locking cylinder 23 can be pre-assembled on the carrier element 20 before the handle part 10 and the carrier element 20 are joined together, while the reinforcing element 13 for the locking cylinder 23, which can also be described as a so-called “socket”, can be pre-assembled on the handle part 10. According to the invention, a fixing unit 30, e.g. in the form of an engaging connection, is formed between the reinforcing element 13 and the handle part 10. In order to fix the handle device 1 according to the invention to the movable part of the vehicle, only two individually manageable units 10, 20 have to be handled, namely on the one hand the carrier element 20 with the already pre-assembled locking cylinder 23 and on the other hand the handle part 10 with the already pre-assembled reinforcing element 13 for the locking cylinder 23. The installer can easily and comfortably handle the carrier element 20 with one hand and the handle part 10 with the other hand. The carrier element 20 and the handle part 10 are assembled to the movable part by interaction. This means that the handle device 1 can be assembled in only one assembling step, i.e. by performing only one plug-in movement of the handle part 10 on the carrier element 20. To secure the two units 10, 20, namely the carrier element 20 and the handle part 10, with each other and thus the handle device 1 on the movable part, a securing element 60 can be retrofitted, as shown in FIGS. 7a and 7b below. In this way, the handle 1 is secured to the movable part in a loss-proof manner. The fixing unit 30 according to the invention thus enables a simplified assembly of the handle device 1 on the movable part.

As shown in FIGS. 1 and 2 and 7a and 7b, the locking cylinder 23 is arranged in the handle part 10 behind a cap 18. The cap 18 can be used to expose the locking cylinder 23 in an emergency. According to the invention, the handle part 10 can be designed as a fixed handle part 10. In order to be able to actuate the movable part without a relative movement of the handle part 10 to the movable part, the locking cylinder 23 can act directly mechanically on a locking pawl in a door lock of the movable part. Thus, the locking cylinder 23 cannot act mechanically with a central locking system, but directly with the lock or the locking pawl. Furthermore, an extension 24 for a bearing bush 25 can be provided on the locking cylinder 23. FIG. 2 schematically shows two locking positions I, II of the locking cylinder 23.

As shown in FIG. 1, the handle part 10 comprises a first holding means 11 and a second holding means 12 at opposite ends E1, E2 over its longitudinal extension L. The first holding means 11 and the second holding means 12 serve for the mechanical fixing of the handle part 10 to the carrier element 20. In addition to the first holding means 11 and the second holding means 12, the carrier element 20 is provided with corresponding openings as bearing positions 21, 22 in which the first holding means 11 and the second holding means 12 can be received. The first holding means 11 and the second holding means 12 are designed as linear projections or pins at the opposite ends E1, E2 of the handle part 10, which project in the same direction from the handle part 10 and are aligned essentially parallel to each other.

The carrier element 20 comprises a first bearing position 21 for the first holding means 11 of the handle part 10 and a second bearing position 22 for the second holding means 12 of the handle part 10. Together, the first bearing position 21 and the first holding means 11 as well as the second bearing position 22 and the second holding means 12 each form a guiding unit 40. This comprises the advantage that the functionality of the handle device 1 can be extended with only a few means, wherein the first bearing position 21 and the first holding means 11 as well as the second bearing position 22 and the second holding means 12 as a part of the guiding unit 40 can not only contribute to the fixing of the handle part 10 to the carrier element 20, but also to a simple, fast and correct assembly of the handle device 1 to the movable part.

In an embodiment of the invention, as shown for example in FIG. 3a, the handle device 1 can be used on a driver's door. The reinforcing element 13 can be designed in the form of a solid collar element for the locking cylinder 23, which can circumferentially enclose the locking cylinder 23 in the assembled state of the handle device 1. For this purpose, the reinforcing element 13 can comprise a preferably cylindrical receptacle 13a for the locking cylinder 23, as shown in FIG. 3a. Thus, the reinforcing element 13 according to the invention can enclose the locking cylinder 23 in such a way that there are hardly any positions of attack on the locking cylinder 23 with a possible tool. Thus, the burglary resistance of the handle device 1 according to the invention can be increased. It is also conceivable that the reinforcing element 13 could be made of a metal, an alloy or a ZAMAK alloy.

In an embodiment of the invention shown for example in FIG. 3b, the handle device 1 can be used on a passenger door. The reinforcing element 13 can be in the form of an aperture 13b. It is conceivable that the reinforcing element 13 can be made of a plastic, preferably in the form of an injection molded part.

As can be seen from FIGS. 3a and 3b, the handle device 1 according to the invention can be used for both a driver's door and a passenger door. Since passenger doors often do not comprise a locking cylinder, there is no need to use a solid reinforcing element 13, so that light materials, such as plastic, can be used for the reinforcing element 13 instead of hard and heavy materials, such as a ZAMAK alloy. The same forming of the reinforcing element 13 for the driver's door and the passenger door, but made of different materials, can be advantageously used to enable a uniform appearance on the vehicle.

As FIGS. 1, 2, 3a, 3b, 6a, 6b and 7a and 7b also show, a second fixing unit 50 can be provided between the carrier element 20 and the reinforcing element 13 in order to fix the reinforcing element 13 to the carrier element 20 in a form- and/or force-locking manner. The reinforcing element 13 can thus help to fix the handle part 10 to the carrier element 20. For this purpose, an elongated projecting rib with a groove-like guide 51 for receiving a corresponding guiding means of the carrier element 20, which is not shown in the figures, can be formed in the frame of the second fixing unit 50. In this way, the assembly of the handle device 1 can be further simplified and, advantageously, be performed precisely.

As shown in FIG. 4a below, the reinforcing element 13 with a bearing arm 31a can be designed as part of the fixing unit 30 according to the invention, which can be received in a complementary bearing guide 31b at the handle part 10, in particular at a first holding means 11, the bearing guide 31b being shown in FIG. 4b. A form- and/or force-locking connection is produced between the bearing guide 31b on the handle part 10 and the bearing arm 31a on the reinforcing element 13, as shown in FIGS. 3a, 3b, 5, 6a and 6b and 7a. When inserted in the bearing guide 31b, the bearing arm 31a can also form a part of a guiding unit 40 with the first holding means 11.

A recess 36 can be provided within the bearing arm 31a to save material and reduce weight.

As further shown in FIGS. 4a and 4b, the reinforcing element 13 at the end of the bearing arm 31a on a plateau 32 can comprise a supporting surface 32a for a corresponding supporting side 32b of the handle part 10, in particular of the first holding means 11. When the reinforcing element 13 is fixed to the handle part 10, the supporting surface 32a of the reinforcing element 13 and the supporting side 32b of the handle part 10 lie on top of each other, as shown in the view of FIG. 1. By placing the supporting side 32b of the handle part 10 against the supporting surface 32a of the reinforcing element 13, the end position of the reinforcing element 13 can be marked on the handle part 10.

As shown in FIG. 4a, the bearing arm 31a and the plateau 32 form an inverted T-piece to a surface 13e of the reinforcing element 13. The surface 13e of the reinforcing element 13 can preferably be adapted to the outer form of the handle part 10. From the surface 13e of the reinforcing element 13 in the direction of the carrier element 20, a cylindrical receptacle 13a for the locking cylinder 23 is extending, which is formed with a shell surface 13d. The shell surface 13d can enclose and thus reinforce the locking cylinder 23.

As further shown in FIGS. 4a and 4b, the reinforcing element 13 can comprise a positioning means 33a and the handle part 10, in particular the first holding means 11, can comprise a positioning receptacle 33b. Conversely, it is also conceivable that a positioning means can be formed on the handle part 10 and a positioning receptacle on the reinforcing element 13. The positioning means 33a on the reinforcing element 13 and the positioning receptacle 33b on the handle part 10 can engage when the reinforcing element 13 is fixed on the handle part 10, as shown in FIG. 6a in a sectional view through the fixing unit 30. Thus, the end position of the reinforcing element 13 at the handle part 10 can be formed and/or secured at least in a longitudinal direction L of the handle part 10.

As further shown in FIGS. 4a and 4b, the reinforcing element 13 may comprise a stop opening 34a and the handle part 10, in particular the first holding means 11, a stopping means 34b or vice versa, which engage when the reinforcing element 13 is fixed to the handle part 10. By interaction of the stop opening 34a with the stopping means 34b, the end position of the reinforcing element 13 on the handle part 10 can be marked and formed and/or secured as indicated in FIG. 6b.

As can also be seen from FIG. 4b and FIG. 5, the reinforcing element 13 may comprise an engaging element 35a and the handle part 10, in particular the first holding means 11, a counter-engaging element 35b, which can secure the reinforcing element 13 in the fixed state on the handle part 10, in particular against being pulled out, in a form- and/or force-locking manner. Thus, the end position of the reinforcing element 13 can be secured downwards and away from the handle part 10. The corresponding engaging and counter-engaging elements 35a, 35b on the reinforcing element 13 and on the handle part 10 thus serve to produce the form- and/or force-locking connection between the reinforcing element 13 and the handle part 10.

FIGS. 6a and 6b show the fixing unit 30 according to the invention only schematically using the example of a reinforcing element 13 in the form of an aperture 13b. The fixing unit 30 according to the invention can be constructed correspondingly with a solid reinforcing element 13 with a receptacle 13a for the locking cylinder 23.

Furthermore, the invention can provide, in the case of a handle device 1, that the fixing unit 30 can form a part of a guiding unit 40 for guiding the handle part in an insertion direction E in a form-locking manner during the assembly on the carrier element 20, preferably along a linear guide 40a, wherein the insertion direction E is shown in FIG. 1. The guiding unit 40 can be provided between the handle part 10 and the carrier element 20 and integrated in the handle device 1 (see a left end E2 and a right end E2 in FIG. 1). The guiding unit 40 can ensure a correct insertion movement of the handle part 10 into the carrier element 20 during the assembly of the handle device 1. Another advantage of the guiding unit 40 is, on the other hand, that the guiding unit 40 guides the handle part 10 along the correct insertion direction E in a form-locking manner so that the handle part 10 cannot tip to the side. Thus, if the handle part 10 can be easily inserted into the carrier element 20, the installer receives a tactile feedback that signals that the insertion direction E is correctly selected and that he can continue with the assembly of the handle part 10. As FIG. 1 also shows, the guiding unit 40 according to the invention creates a linear guide 40a for the handle part 10 on the carrier element 20. A linear guide 40a can be provided at a left end E1 and at a right end E2 of the handle part 10 respectively. This means that the handle part 10 can be inserted simultaneously with both ends E1, E2 on the carrier element 20 in only one assembling step and by means of only one insertion movement in a correct insertion direction E perpendicular to its extension direction L. The installer can tactilely monitor the correctness of the assembly if the handle part 10 encounters little resistance in the preferably linear guide 40a during the insertion movement 20.

The guiding unit 40 can comprise at least one assembling means 11a, 12a on the first holding means 11 and/or on the second holding means 12 of the handle part 10, which can be received in a corresponding guiding means 21a, 22a on the first bearing position 21 and/or on the second bearing position 22 of the carrier element 20. The assembling means 11a, 12a on the first holding means 11 and/or on the second holding means 12 can, for example, be designed in the form of protruding ribs or guiding receptacles. Complementary to this, the guiding means 21a, 22a at the first bearing position 21 and/or at the second bearing position 22 of the carrier element 20 can be designed inversely as guiding receptacles or as protruding ribs. Together, the assembling means 11a, 12a and the guiding means 21a, 22a form a linear guide 40a of the guiding unit 40.

FIG. 2 on the one hand and FIGS. 3a, 3b, 4b, 5 and 7b on the other hand each show a possible embodiment of the handle device 1 according to the invention with one engaging means 11b, 12b each on the first holding means 11 and/or on the second holding means 12 of the handle part 10. The engaging means 11b, 12b serve to fix an end assembling position of the handle part 10 on the carrier element 20 in a form- and/or force-locking manner. Thus, the installer can recognize the correct end assembling position of the handle part 10 on the carrier element 20 if the engaging means 11b, 12b snap into specially designed fixing means 21b, 22b at the first bearing position 21 and at the second bearing position 22 of the carrier element 20 when the end assembling position is reached. The engaging means 11b, 12b and the fixing means 21b, 22b can be designed to correspond to each other as cams or receptacles.

FIGS. 2 and 7a also show that at least on one assembling means 12a, e.g. on the second holding means 12, of the handle part 10, a bore 12e can be provided which can serve as a cable holder. The bore 12e can extend along the entire assembling means 12a and can receive at least one cable 16 in a protected manner. The cable 16 can lead to a sensor element 17 on the handle part 10, which can be provided for actuating the movable part, e.g. for opening the movable part. Thus, the assembling means 12a can not only ensure a form-locking guidance of the handle part 10 in the carrier element 20, but also fulfill another important function, namely a protected guidance of at least one cable 16 from the inside of the handle device 1 behind the movable part to the outside handle part 10.

As FIG. 2 also shows, the guiding unit 40 may be provided with pre-engaging means 11c, 12c, 21c, 22c on the first holding means 11 and/or on the second holding means 12 of the handle part 10 in order to guide the respective fixing means 21b, 22b at the first bearing position 21 and/or at the second bearing position 22 of the carrier element 20 in a form-locking manner during the assembly of the handle part 10 on the carrier element 20 before the end assembling position of the handle part 10 on the carrier element 20 is reached. When the end assembling position of the handle part 10 on the carrier element 20 is reached, the engaging means 11b, 12b and the corresponding fixing means 21b, 22b can be connected in a form- and/or force-locking manner by a snap-action movement. The installer experiences a snap movement as a haptic feedback, which signals the end assembling position.

According to an embodiment of the invention shown in FIG. 2, a pre-engaging means 13c may be formed on the reinforcing element 13, which may transfer into a pre-engaging means 11c on the first holding means 11 of the handle part 10.

As FIGS. 2 and 7a also indicate, the first end E1 and the second end E2 of the handle part 10 may each comprise a sealing 14, 15, which can protect the inside of the handle part 10 from moisture and dirt. The views in FIGS. 3a and 3b show pin receptacles 14a, which can be used to fix a sealing 14 to the first end E1 of the handle part 10. At the second end E2 of the handle part 10, corresponding pin receptacles for fixing a sealing 15 are conceivable.

In addition, as shown in FIG. 2 and FIGS. 7a and 7b, the first holding means 11 and the second holding means 12 of the handle part 10 are each provided with connecting means 11d, 12d which can interact with a securing element 60 shown in FIGS. 7a and 7b to secure the handle part 10 in the end assembling position on the carrier element 20. In addition, FIG. 2 and FIGS. 7a and 7b show a screw 61 for the securing element 60 which, when the securing element 60 is moved along the longitudinal direction L, can stabilize the movement of the securing element 60 and/or serve as a stop in an end position of the securing element 60.

FIGS. 7a and 7b finally show the handle part 10 secured by the securing element 60. For this purpose, the securing element 60 can be moved in a longitudinal direction L by means of an adjusting screw 62. The adjusting screw 62 can be tightened by rotating it in a rotation direction D relative to a screw nut 26 which can be fixed to the carrier element 20. The securing element 60 can be designed in the middle in the form of a securing plate 60b and respectively at the end in the form of a securing fork 60a for the respective holding means 11, 12 on the handle part 10.

When the securing element 60 is displaced along the longitudinal direction L from left to right, a wider assembling opening 60c for the respective holding means 11, 12 at one fork-like end of the securing element 60 in each case can transfer into a narrower securing opening 60d, in which a connecting means 11d, 12d of the first holding means 11 and the second holding means 12 of the handle part 10 can engage in a form-locking manner. Afterwards, it is no longer possible to pull out the handle part 10 perpendicular to the extension direction L of the securing element 60 because the securing element 60 stands in the way of such a movement. Consequently, the securing element 60 can prevent that the handle part 10 can be pulled out unauthorized and/or unintentionally along the form-locking guide 40a of the guiding unit 40, which was created for the assembly. This provides a simple, secure handle device 1 that is also easy to assemble.

The above explanation of the embodiments describes the present invention exclusively in the context of examples. Of course, individual features of the present invention can be freely combined with each other, if technically reasonable, without leaving the scope of the present invention/claims.

### LIST OF REFERENCE SIGNS

1 handle device
10 handle part
11 first holding means
11a assembling means
11b engaging means
11c pre-engaging means
11d connecting means
12 second holding means
12a assembling means
12b engaging means
12c pre-engaging means
12d connecting means
12e bore
13 reinforcing element
13a receptacle
13b aperture
13c pre-engaging means
13d shell surface
13e surface
14 sealing
14a pin receptacles
15 sealing
16 cable
17 sensor element
18 cap
20 carrier element
21 first bearing position
21a guiding means
21b fixing means
21c pre-engaging means
22 second bearing position
22a guiding means
22b fixing means
22c pre-engaging means
23 locking cylinder
24 extension on the locking cylinder for a bearing bush
25 bearing bush
26 screw nut
30 fixing unit
31a bearing arm
31b bearing guide
32 plateau
32a supporting surface
32b supporting side
33a positioning means
33b positioning receptacle
34a stop opening
34b stopping means
35a engaging element
35b counter-engaging element
36 recess
40 guiding unit
40a linear guide
50 second fixing unit
51 guide
60 securing element
60a securing fork
60b securing plate
60c assembling opening
60d securing opening
61 screw
62 adjusting screw
A cutting direction along the first holding means
B cutting direction transverse to the first holding means
D rotation direction of the adjusting screw
E1 end of the handle part
E2 end of the handle part
L extension direction, longitudinal direction
E insertion direction
I first closed position
II second closed position

1-24. (canceled)

25. A handle device for a movable part of a vehicle, comprising:
a handle part for actuating the movable part,
a carrier element for fixing the handle part to the movable part,
wherein a locking cylinder for unlocking the movable part at least in an emergency can be arranged on the carrier element,
wherein a reinforcing element is provided on the handle part, in which the locking cylinder can be at least partially received,
and wherein a fixing unit is provided between the handle part and the reinforcing element in order to fix the reinforcing element to the handle part in at least a form-locking or force-locking manner.

26. The handle device according to claim 25,
wherein
at least a locking cylinder is arranged on the carrier element, wherein the reinforcing element is designed in the form of a solid collar element for the locking cylinder in order to enclose the locking cylinder at least partially on the circumference in the mounted state of the handle device or the reinforcing element is designed in the form of an aperture.

27. The handle device according to claim 25,
wherein
a second fixing unit is provided between the carrier element and the reinforcing element in order to fix the reinforcing element to the carrier element in at least a form-locking or force-locking manner.

28. The handle device according to claim 25,
wherein
at least the fixing unit forms part of a guiding unit which is designed in such a way to guide the handle part in a form-locking manner at the assembly on the carrier element or
the handle part comprises a first holding means and a second holding means at opposite ends in a longitudinal direction.

29. The handle device according to claim 25,
wherein
the reinforcing element comprises a bearing arm which forms a part of the fixing unit.

30. The handle device according to claim 25,
wherein
the reinforcing element comprises a supporting surface and the handle part comprises a supporting side, which butt against each other in the fixed state of the reinforcing element on the handle part.

31. The handle device according to claim 25,
wherein
the reinforcing element comprises a positioning means and the handle part comprises a positioning receptacle which secures the reinforcing element in the fixed state on the handle part in at least a form- or force-locking manner at least in a longitudinal direction of the handle part.

32. The handle device according to claim 25,
wherein
the reinforcing element comprises a stop opening and the handle part comprises a stopping means, which engage into each other in the fixed state of the reinforcing element on the handle part.

33. The handle device according to claim 25,
wherein
the reinforcing element comprises an engaging element and the handle part comprises a counter-engaging element, which secure the reinforcing element in the fixed state on the handle part in at least a form- or force-locking manner.

34. The handle device according to claim 25,
wherein
the carrier element comprises a first bearing position for the first holding means of the handle part and a second bearing position for the second holding means of the handle part.

35. The handle device according to claim 25,
wherein
the guiding unit comprises at least one assembling means on at least a first holding means or on a second holding means of the handle part.

36. The handle device according to claim 25,
wherein
the guiding unit comprises at least one guiding means at at least a first bearing position or at a second bearing position of the carrier element.

37. The handle device according to claim 25,
wherein
an assembling means on at least a first holding means or on a second holding means of the handle part comprises a bore which serves as a cable holder.

38. The handle device according to claim 25,
wherein
at least the guiding unit comprises at least one engaging means on at least a first holding means or on a second holding means of the handle part in order to fix an end assembling position of the handle part on the carrier element in at least a form- or force-locking manner or
the guiding unit comprises at least one fixing means at least at a first bearing position or at a second bearing position of the carrier element.

39. The handle device according to claim 25,
wherein
the reinforcing element comprises a pre-engaging means for guiding a fixing means at the first bearing position of the carrier element during the assembly of the handle part on the carrier element in a form-locking manner, before the end assembling position of the handle part on the carrier element is reached.

40. The handle device according to claim 25,
wherein
the handle part comprises at least one connecting means which interacts with a securing element in order to secure the handle part in at least an end assembling position of the handle part on the carrier element or the reinforcing element in the fixed state on the handle part.

41. The handle device according to claim 25,
wherein
at least a securing element is provided which serves to secure at least the handle part in an end assembling position on the carrier element or the reinforcing element in the fixed state on the handle part or the handle device is designed as a part of a locking system of the vehicle.

42. A method for assembling a handle device on a movable part which is designed with
a handle part for actuating the movable part,
and a carrier element for fixing the handle part to the movable part,
wherein a locking cylinder for unlocking the movable part at least in an emergency is provided on the carrier element,
and wherein a reinforcing element for the locking cylinder is provided on the handle part, which at least partially encloses the locking cylinder on the circumference,
wherein
the reinforcing element is pre-assembled in the handle part and is assembled with the handle part from the outside on the movable part.

43. The method according to claim 42,
wherein
at least the locking cylinder is pre-assembled in the carrier element and is assembled with the carrier element from the inside on the movable part.
